(19) United States
(12) Patent Application Publication
(10) Pub. No.: US 2013/0343252 A1
(43) Pub. Date: Dec. 26, 2013

(54) Power Saving for Mobile Terminals

(71) Applicant: Broadcom Corporation, Irvine, CA (US)

(72) Inventors: Soumen CHAKRABORTY, Bangalore (IN); Erik STAUFFER, Mountain View, CA (US); Sindhu VERMA, Bangalore (IN)

(21) Appl. No.: 13/852,766

(22) Filed: Mar. 28, 2013

Related U.S. Application Data
(60) Provisional application No. 61/663,942, filed on Jun. 25, 2012.

(51) Int. Cl. H04W 52/02

(52) U.S. Cl. CPC H04W 52/0261
USPC 370/311

(57) ABSTRACT

Embodiments provide power saving schemes for a user equipments (UE) in low power supply state. The power saving schemes include network-assisted power saving schemes and UE-triggered power saving schemes. Network-assisted power saving schemes require network awareness of the low power supply state of the UR Thus, embodiments provide the UE the ability to communicate its power supply state to the network. UE-triggered power saving schemes may or may not require network awareness of the UE s power supply state andd/or of the execution of the HE-triggered power saving scheme at the UE.

### CROSS-REFERENCE TO RELATED APPLICATIONS

The present invention claims the benefit of U.S. Provisional Application No. 61/663,942, filed Jun. 25, 2012, which is incorporated herein by reference in its entirety.

### BACKGROUND

1. Field of the Invention

The present disclosure relates generally to power saving for mobile terminals.

2. Background Art

Commonly, a mobile terminal in a wireless communication network is operated from a portable power supply without the ability to re-charge the portable power supply (for example when the mobile terminal is moving). At some point, the portable power supply becomes so depleted that the mobile terminal enters into a low power supply state. The continuing use of the mobile terminal under normal operating conditions can ultimately completely deplete the portable power supply of the mobile terminal, causing the mobile terminal to shut down. Accordingly, there is a need for power saving schemes for mobile terminals in low power supply state.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an example network environment in which embodiments can be used or implemented.

FIGS. 2 and 3 illustrate example receiver architectures.

FIG. 4 illustrates an example process according to an embodiment.

FIGS. 5-13 illustrate example power saving processes for mobile terminals according to embodiments.

FIG. 14 is a block diagram on an example user equipment according to art embodiment.

The present disclosure will be described with reference to the accompanying drawings. Generally, the drawing in which an element first appears is typically indicated by the leftmost digit(s) in the corresponding reference number.

### DETAILED DESCRIPTION OF EMBODIMENTS

For purposes of this discussion, the term “module” shall be understood to include at least one of software, firmware, and hardware (such as one or more circuits, microchips, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

In the following disclosure, terms defined by the Long-Term Evolution (LTE) standard are used. For example, the term “eNodeB” is used to refer to What is commonly described as base station (BS) or base transceiver station (BTS) in other standards. The term “User Equipment (UE)” is used to refer to What is commonly described as a mobile station (MS) or mobile terminal in other standards. The term “component carriers (CCs)” is used to refer to resource blocks (defined in terms or frequency and/or time) that are aggregated (logically grouped) together. However, as will be apparent to a person of skill in the art based on the teachings herein, embodiments are not limited to the LTE standard and can be applied to other wireless communication standards (e.g., WiMAX, WCDMA, etc.). Further, embodiments are not limited to cellular networks and can be used or implemented in other kinds of wireless communication access networks (e.g., wireless local area network (WLAN), Bluetooth, etc.).

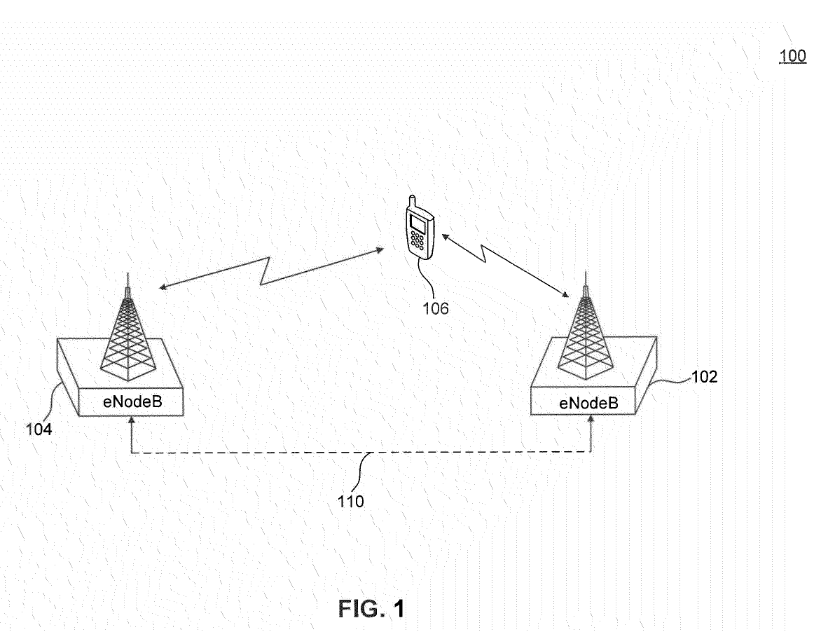

FIG. 1 illustrates an example cellular network environment 100 in which embodiments can be used or implemented. Example cellular network environment 100 is provided for the purpose of illustration only and is not limiting of embodiments.

As shown in FIG. 1, example network environment 100 includes an Evolved Node B (eNodeB) 102, an eNodeB 104, and a User Equipment (UE) 106. UE 106 can be any portable device capable of cellular-based communication, including a cellular phone, tablet, laptop, etc. Typically, UE 106 is operated from a portable power supply (e.g., battery, solar cells, etc.). At any given time, the portable power supply has a lifetime (amount of time until it is completely depleted) that depends on the use of UE 106. The portable power supply can be re-charged from another power supply (e.g., wall AC power supply, vehicle DC power supply, etc.).

eNodeB 102 and eNodeB 104 can be in nearby cells of a cellular network, within the same cell of the cellular network, or in nearby sectors of the same cell of the cellular network. Further, eNodeB 102 and eNodeB 104 can be part of a microcell, picocell, or femtocell network, located outdoor and/or indoor. In an embodiment, eNodeB 102 and eNodeB 104 communicate via a backhaul network (e.g., X2 interface) link 110. eNodeBs 102 and 104 may each support a plurality of serving cells (each serving cell is the equivalent of a base station and has a unique cell ID that identifies it to UEs).

Carrier Aggregation (CA) is a feature of Release-10 of the 3^{rd} Generation Partnership Project (3GPP) LTE-Advanced standard, which allows multiple resource blocks (defined in terms of frequency and/or time) from/to multiple respective serving cells to be logically grouped together (aggregated) and allocated to the same UE. The aggregated resource blocks are known as component carriers (CCs) in the LTE-Advanced standard. The UE may thus receive/transmit multiple CCs (more specifically, receive/transmit data over the multiple CCs) simultaneously from/to the multiple respective serving cells, thereby effectively increasing the downlink/uplink bandwidth of the UE. The multiple respective serving cells may or may not be located at the same eNodeB of the cellular network. For instance, in example network environment 100, depending on its receiver capabilities (e.g., whether it supports CA), UE 106 may communicate with one or more serving cells of eNodeB 102 and/or eNodeB 104 For example, UE 106 may communicate with a primary serving cell and a secondary serving cell both located at eNodeB 102. Alternatively, or additionally, UE 106 may communicate with one or more serving cells located at eNodeB 104.

As would be understood by a person of skill in the art based on the teachings herein, embodiments are not limited by the above example scenario. In particular, embodiments are not limited to cellular networks and can be used in other types of wireless communication access networks (e.g., WLAN, Bluetooth, etc.).

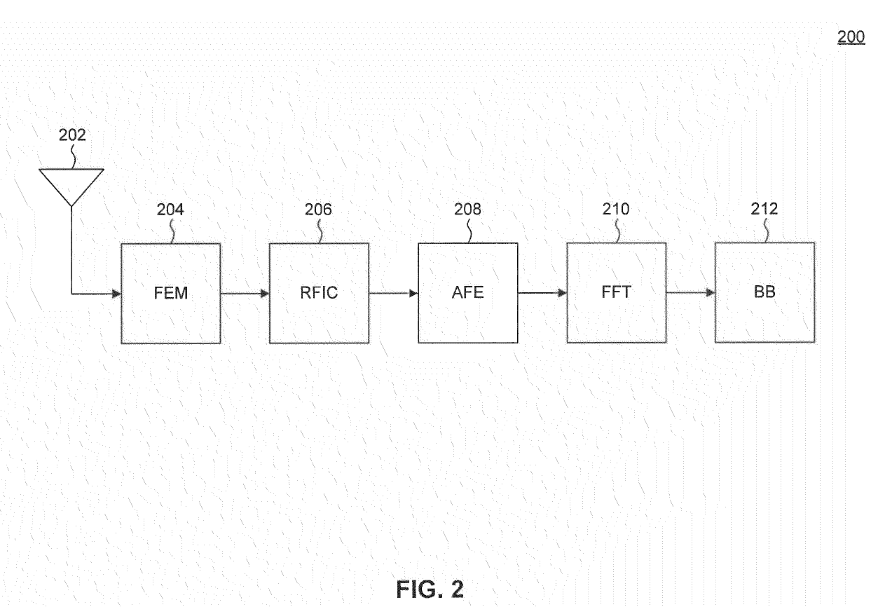

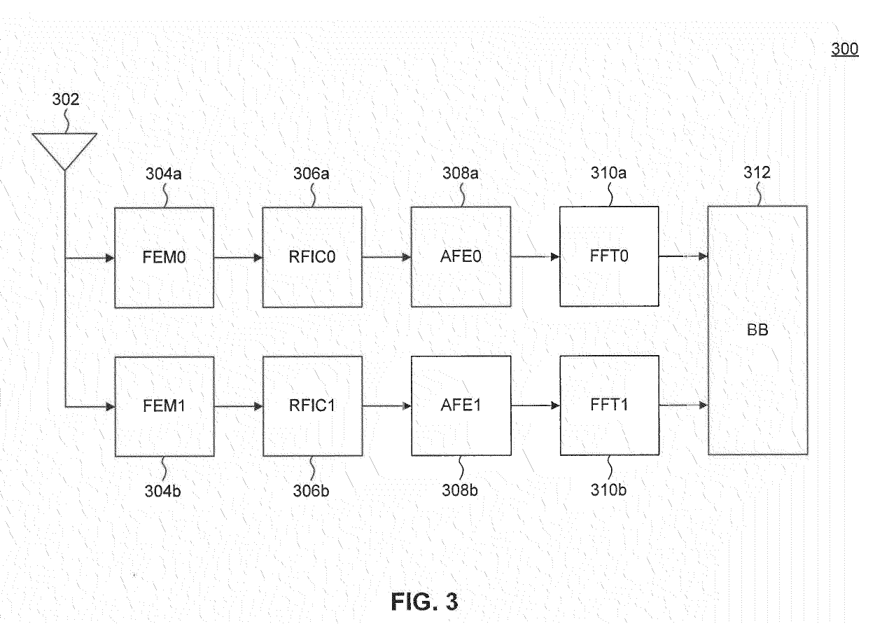

FIGS. 2 and 3 illustrate example receiver architectures. The example receiver architectures of FIGS. 2 and 3 are provided for the purpose of illustration only and are not limiting of embodiments. A typical UE (e.g., UE 106) may implement one (or a similar one) of the receiver architectures illustrated in FIGS. 2 and 3. Depending on its implemented receiver architecture, the UE may support one or more forms of CA.

FIG. 2 illustrates an example receiver architecture 200 having a single receive chain and a single receive antenna 202. The receive chain includes a front-end module (FEM) 204 (e.g., may include discrete components such as duplexers, switches, and filters), a radio frequency (RE) integrated circuit (RFIC) 206 (e.g., may include analog components such as mixers, low-pass filters, etc.), an analog front end (AYE) 208 (e.g., may include mixed signal components such as DACs), a Fast Fourier Transform (FFT) module 210, and a baseband (BB) processor 212.

FIG. 3 illustrates an example receiver architecture 300 having two receive chains that share a single receive antenna 302 and a BB processor 312. Each of the two receive chains includes a FEM 304, a RFIC 306, an AFE 308, and a FFT module 310. Having two receive chains, receiver architecture 300 can process at least two received signals simultaneously. In other embodiments, the two receive chains can share a single FEM.

Commonly, the UE (e.g., UE 106 in example network environment 100) is operated from its portable power supply without the ability to re-charge the portable power supply (for example when the UE is moving). At some point, the portable power supply becomes so depleted that the LIE enters into a low power supply state. The continuing use of the UE under normal operating conditions can ultimately completely deplete the portable power supply of the UE, causing the UE to shut down. Accordingly, there is a need for power saving schemes for UEs in low power supply state.

Embodiments provide power saving schemes for a UE in low power supply state. The power saving schemes include network-assisted power saving schemes and UE-triggered power saving schemes. Network-assisted power saving schemes require network awareness of the low power supply state of the UE. Thus, embodiments provide the UE the ability to communicate its power supply state to the network. UE-triggered power saving schemes may or may not require network awareness of the UE's power supply state and/or of the execution of the UE-triggered power saving scheme at the UE. Further description of embodiments is provided below.

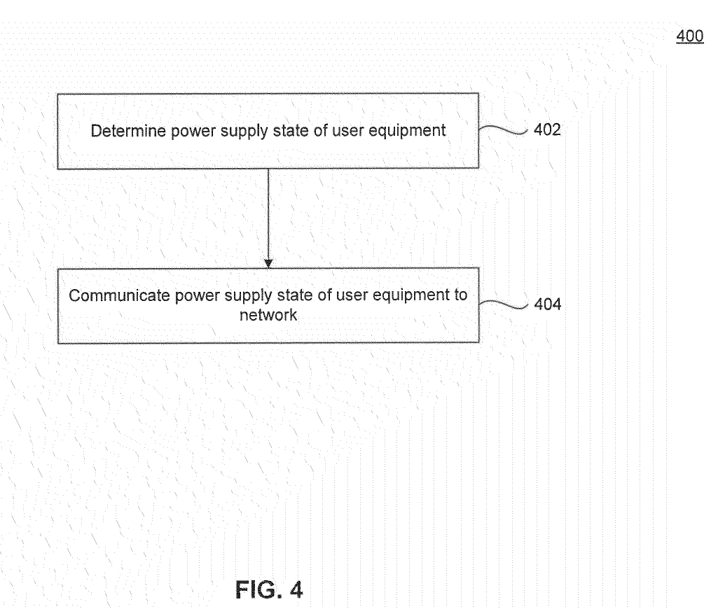

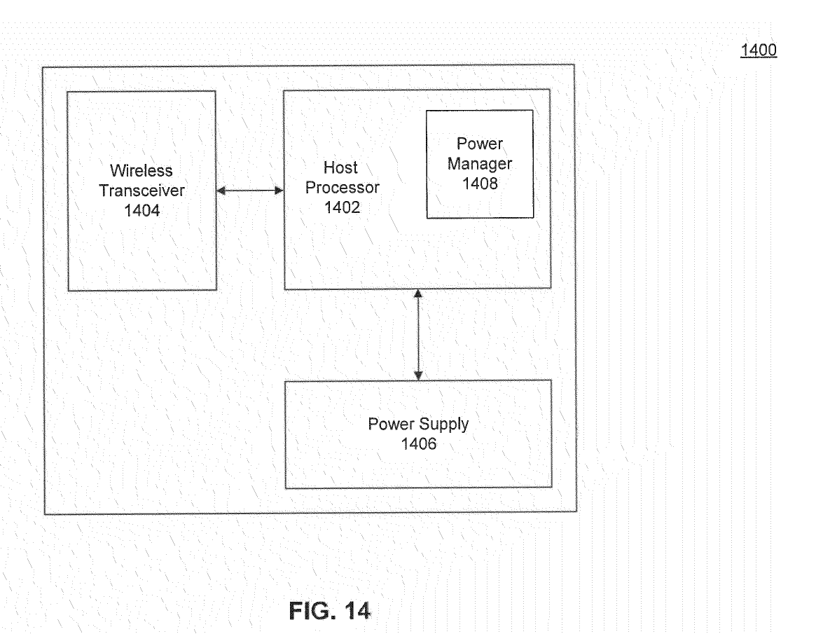

FIG. 4 illustrates an example process 400 according to an embodiment. Example process 400 is provided for the purpose of illustration only and is not limiting of embodiments. Example process 400 includes a process for the UE to communicate its power supply state to the network. Example process 400 can be performed by example UE 1400 illustrated in FIG. 14. Example UE 1400 includes a host processor 1402 (which includes a power manager module 1408), a power supply 1406, and a wireless transceiver 1404.

In an embodiment, the UE performs process 400 periodically to inform the network periodically of its power supply state and/or when the remaining charge level (or the remaining lifetime) of the portable supply is below some threshold. Alternatively, the UE performs process 400 only when the UE desires to change its operating condition, for example from a normal power mode to a low power mode, or vice versa. In another embodiment, the UE is permitted only a defined number of operating condition changes in a given time interval, and therefore performs process 400 in accordance with this defined number.

As shown in FIG. 4, process 400 begins in step 402, which includes determining a power supply state of the UE. In an embodiment, step 402 is performed by a power manager module (e.g., power manager module 1408) of the UE, which measures the remaining charge level and/or estimates the remaining lifetime of the portable power supply (e.g., power supply 1406) of the UE. Based on the remaining charge level and/or the remaining lifetime of the portable power supply, the power manager module can determine a power supply state of the UE. For example, if the remaining charge level (or the remaining lifetime) is below a predetermined threshold (e.g., the remaining charge level is below 10% of the full charge level, the remaining lifetime is less than 5 minutes, etc.), the power manager module determines that the UE is in a low power supply state. Otherwise, the power manager module determines that the UE is in a normal power supply state, in other embodiments, more than two power supply states (e.g., high, medium, low, emergency) can be implemented.

In an embodiment, the power manager module can take into account whether or not the UE is connected to a charging power supply in determining the UE's power supply state. For example, if the UE's portable power supply is at a low charge level but is being re-charged, the power manager module may determine that the UE's power supply is in a normal power supply state instead of a low power supply state. Alternatively, in such a situation, the power manager module may prompt the user of the UE as to whether to operate the UE in a low power or normal power mode. The power manager module then determines the UE's power supply state based on the user's response. In other embodiments, the user can manually configure the UE's power mode, which can override the power manager module determination.

After determining the power supply state of the UE in step 402, process 400 proceeds to step 404, which includes communicating the power supply state of the UE to the network. In an embodiment, step 404 includes the UE transmitting (e.g., via wireless transceiver 1404) the power supply state to a serving cell of the network. For example, referring to FIG. 1, UE 106 may transmit its power supply state to its primary serving cell located at eNodeB 102. The serving cell can share the received power supply state of the UE with other serving cells at the same or different eNodeBs, and/or with other entities of the network (e.g., entities of the Evolved Packet Core (EPC) in LTE). For example, the UE can transmit its power supply state only to its primary serving cell, which shares the power supply state with any secondary serving cells of the UE. In another embodiment, the UE transmits its power supply state to all serving cells of the UE.

In an embodiment, the power supply state is transmitted on an uplink control channel from the UE to the serving cell. For example, the power supply state is transmitted by the UE on the uplink Dedicated Control Channel (DCCH) defined in the UE standard. In an embodiment, the power supply state is communicated to the serving cell by sending a power preference indication (PPI) message from the UE to the serving cell, where the PPI message includes a power mode preference of the UE. In an embodiment, the power mode preference of the UE is selected based on the power supply state of the UE determined in step 402. In particular, the power mode preference includes a low power mode when the determined power supply state corresponds to a low power state and a normal power mode when the determined power supply state corresponds to a normal power state. As such, the PPI message can consist of a single bit. In other embodiments, more than two power supply states (and more than two UE power modes) can be implemented, and therefore the PPI message can include more than one bit.

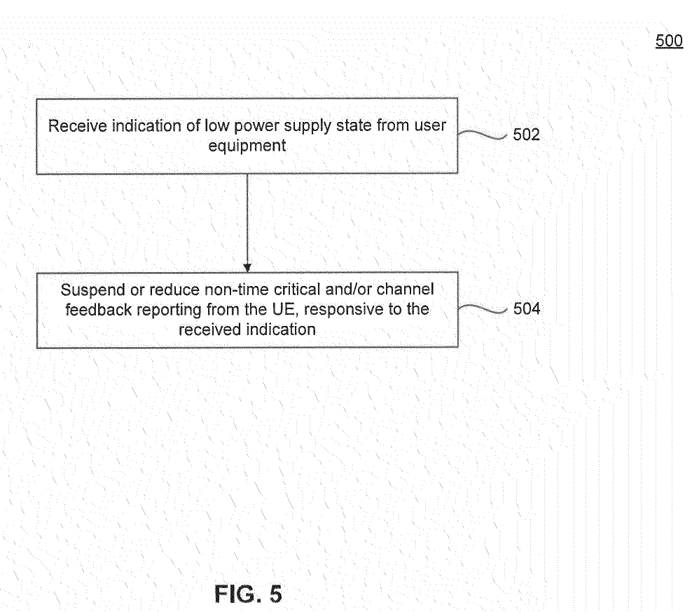

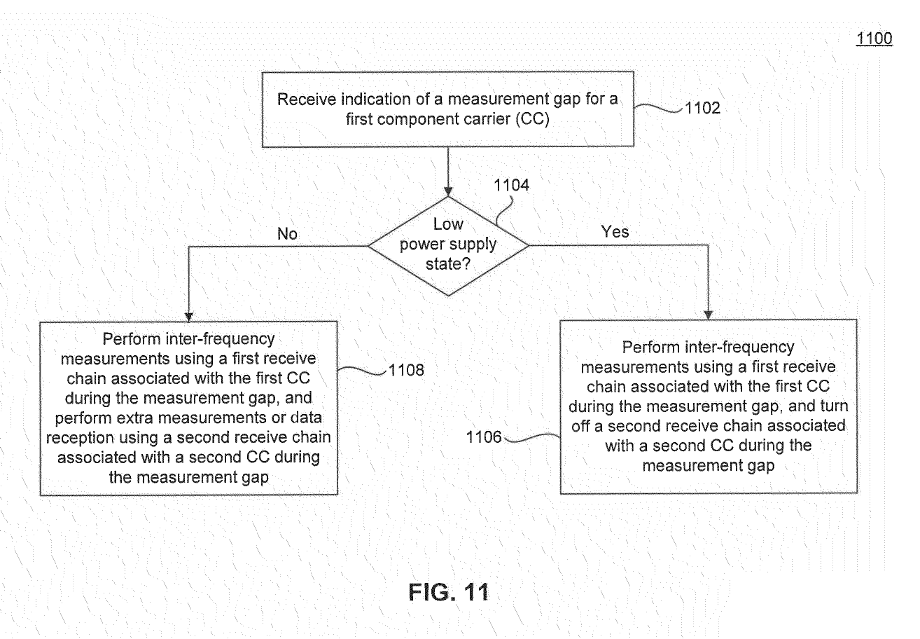

FIGS. 5-13 illustrate example power saving processes for mobile terminals according to embodiments. The example processes illustrated in FIGS. 5-10 correspond to network-assisted power saving schemes, which include the UE communicating its power supply state to the network, for example using process 400 described above. FIGS. 11-13 correspond to UE-triggered power saving schemes, which can be implemented with or without the network being aware of the UE's power supply state and/or of the execution of the power saving schemes at the UE. As will be understood by a person of skill in the art based on the teachings herein, any combination of the processes described herein can be used to improve the power supply lifetime at the UE.

FIG. 5 illustrates an example process 500 for improving the power supply lifetime of a UE according to an embodiment. Example process 500 can be performed by a network entity, such as a serving cell, an eNodeB, or other entity (e.g., EPC entity in LTE) of the network, for example.

As shown in FIG. 5, process 500 begins in step 502, Which includes receiving an indication of a low power supply state from the UE. In an embodiment, the indication of a low power supply state is received in a PPI message sent on an uplink control channel by the UE.

Subsequently, in response to the received indication, process 500 proceeds to step 504, which includes suspending or reducing non-time critical and/or channel feedback reporting from the UE, responsive to the received indication in step 502, In an embodiment, step 504 further includes communicating to the UE (e.g., over a downlink control channel) instructions to suspend or reduce non-time critical and/or channel feedback reporting from the UE to the network. When the reporting is of measurements performed by the UE, reducing the reporting can include reducing both measurements and reporting of measurements or reducing reporting only, When the reporting is done periodically, reducing the reporting can include reducing the frequency of the reporting.

In an embodiment, suspending or reducing non-time critical reporting from the UE, as in step 504, includes suspending or reducing automatic neighbor relation (ANR) measurements and reporting from the UE to the network. Typically, ANR measurements and reporting include the UE measuring signal strengths of detected neighboring cells and reporting the measurements to the network. Based on the measured signal strengths, the network can ask the UE to retrieve and report a cell and a Public Land Mobile Network (PLMN) ID list for one or more of the detected neighboring cells. In an embodiment, this includes decoding the Master Information Block (MIB) and the System Information Block 1 (SIB1) of the one or more detected neighboring cells. As such, ANR measurements and reporting can consume significant power at the UE, particularly when the UE is able to detect multiple neighboring cells.

Generally, the network uses the reported information from multiple UEs to dynamically create/update a database of neighbor relations, which provides the network with a view of cell deployment over the coverage area. The network can use the database to determine/update a neighbor cell list for each cell in the network, to estimate the location of cells, and/or to discover other cells in the coverage area, such as user-deployed cells, for example. The neighbor cell list can be communicated to UEs and used by the network to facilitate handovers. Further, the network can use the reported information to create/update a fingerprinting database, which includes observed cells and associated signal strengths at various locations of the coverage area. The network can use the fingerprinting database to improve handovers in the network.

Generally, the network builds the neighbor relations' database and the fingerprinting database gradually over a long period of time, using measurements from a very large number of UEs. Accordingly, suspending or reducing the reporting of automatic neighbor relation (ANR) measurements from the UE to the network, as in step 504, would have minimal or no effect on network or UE performance. Yet, significant power savings can be achieved at the UE by the suspension or reduction of the reporting of ANR measurements.

In another embodiment, suspending or reducing non-time critical reporting from the UE, as in step 504, includes, alternatively or additionally, suspending or reducing reporting of one or more Self Optimizing Network (SON) related messages. In an embodiment, this includes suspending or reducing the reporting of mobility robustness optimization (MRO) related messages from the UE to the network. MRO related messages include messages sent by the UE to the network following handovers by the UE. For example, MRO related messages can include information such as whether or not a handover was successful, the source cell and the target cell of the handover, and the number of Random Access Channel (RACH) attempts by the UE to the target cell until the handover was made. Generally, the network uses MRO related messages from a large number of UEs, over an extended period of time, to tune handover parameters in the networks. As such, MRO related messages from the UE can be suspended or reduced with minimal or no effect on network or UE performance, in order to save power at the UE.

In another embodiment, suspending or reducing reporting of SON related messages includes suspending or reducing reporting of RACH configuration optimization messages from the UE to the network. RACH configuration optimization messages include messages sent by the UE to the network to help the network tune RACH parameters (e.g., RACH transmit power, number of UE RACH retries if no response is received from the network, etc.) based on network conditions. Generally, the network relies on RACH configuration optimization messages from a large number of UEs, over an extended period of time, in order to tune RACH parameters. As such, suspending or reducing the reporting of RACH configuration optimization messages from the UE would have minimal or no effect on network or LIE performance, but can reduce power consumption at the UE.

In an embodiment, suspending or reducing channel feedback reporting from the UE as in step 504, includes suspending or reducing transmission of channel quality indicator (CQI) messages and/or Sounding Reference Signals (SRSs) from the UE to the network. CQI messages are transmitted from the UE to the network to inform the network of the quality of the downlink channel from the serving cell to the UE. Generally, CQI messages are sent from the UE to the network based on periodical CQI calculations at the UE. Based on the CQI messages, the network may modify certain transmit parameters to the UE (e.g., modulation and/or coding schemes (MCSs), transmit power, etc.) to improve reception at the UE. SRSs include signals transmitted from the UE to the eNodeB to help the network estimate the uplink channel from the UE to the eNodeB. Like CQI messages, SRSs are generally transmitted periodically from the UE to the eNodeB and are used by the network to determine transmit parameters from the UE to improve reception at the eNodeB.

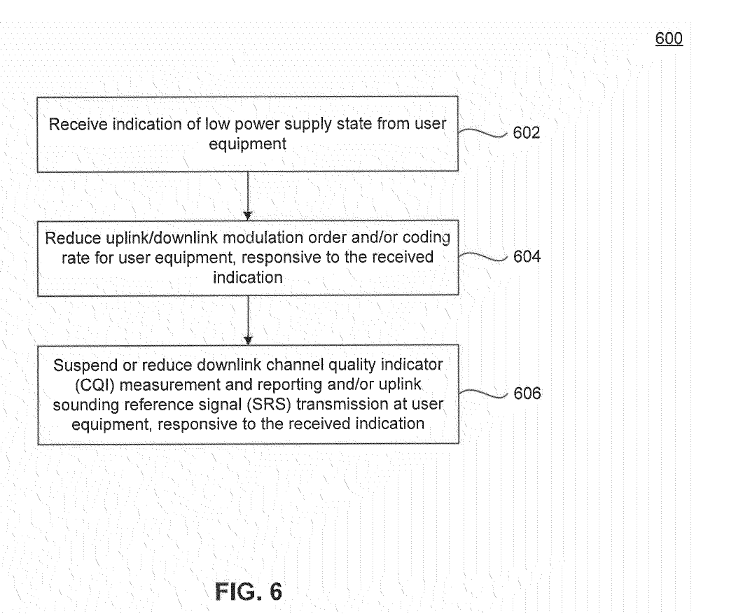

According to embodiments, when the UE is in a low power supply state, the network may permit the UE to suspend or reduce CQI measurements and reporting and/or transmission of SRSs to the network. This results in significant power savings at the UE. In some embodiments, suspending or reducing CQI/SRS transmission from the UE will not have a significant effect on performance at the UE and/or at the eNodeB (e.g., the UE may be very close to the eNodeB), and the UE can thus save power without its performance being affected in terms of other measures. In other embodiments, reception performance at the UE and/or at the eNodeB may be affected, but the network can compensate for any performance degradation, if necessary. For example, the network can instruct the UE to use lower order/rate MCSs, as described below with reference to FIG. 6, in order to ensure acceptable quality. The UE will have lower uplink/downlink throughput using more conservative MCSs but longer power supply lifetime as a result of the suspension/reduction of channel feedback reporting.

FIG. 6 illustrates another example process 600 for improving the power supply lifetime of a UE according to an embodiment. Example process 600 can be performed by a network entity, such as a serving cell, an eNodeB, or other entity (e.g., EPC entity in LTE) of the network, for example.

As shown in FIG. 6, process 600 begins in step 602, which includes receiving an indication of a low power supply state from the UE. In an embodiment, the indication of a low power supply state is received in a PPI message sent on an uplink control channel by the UE.

Subsequently, in response to the received indication, process 600 proceeds to step 604, which includes reducing the uplink and/or downlink modulation order and/or the uplink and/or downlink coding rate for the UE, responsive to the received indication. The lower order/rate uplink/downlink MCSs improve decoder performance at the UE and/or at the serving cell, and allow for channel feedback reporting to be relaxed at the UE. Accordingly, in step 606, process 600 further includes suspending or reducing downlink CQI measurement and reporting and/or uplink SRS transmission from the UE to the network. In an embodiment, where step 604 includes reducing the downlink modulation order and/or the downlink coding rate for the UE, step 606 includes suspending or reducing CQI measurement and transmission of CQI messages from the UE. In another embodiment, where step 604 includes reducing the uplink modulation order and/or the uplink coding rate for the UE, step 606 includes suspending or reducing the transmission of Sounding Reference Signals (SRSs) from the UE.

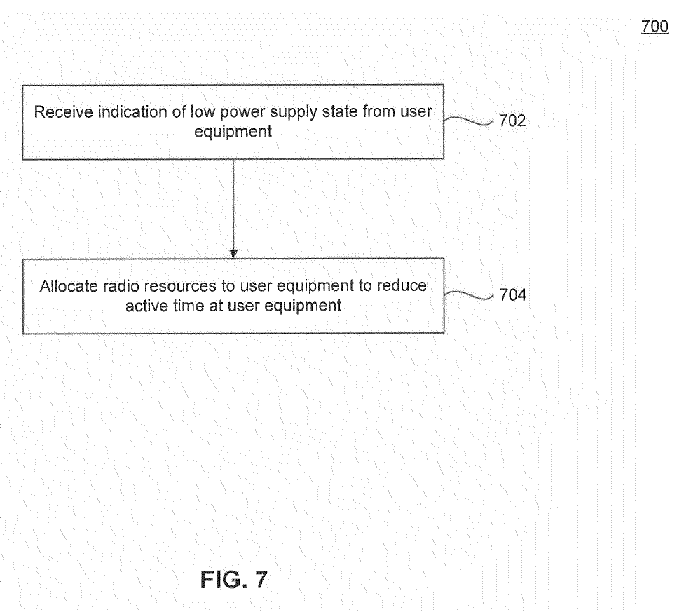

FIG. 7 illustrates another example process 700 for improving the power supply lifetime of a UE according to an embodiment. Example process 700 can be performed by a network entity, such as a serving cell, an eNodeB, or other entity (e.g., EPC entity in LTE) of the network, for example.

As shown in FIG. 7, process 700 begins in step 702, which includes receiving an indication of a low power supply state from the UE. In an embodiment, the indication of a low power supply state is received in a PPI message sent on an uplink control channel by the UE.

Subsequently, in response to the received indication, process 700 proceeds to step 702, which includes allocating radio resources to the UE to reduce active time at the UE. Radio resources can include downlink and/or uplink radio resources, defined in time and/or frequency. Reducing active time can include reducing the amount of time in which the UE is active to perform at least one activity. For example, reducing active time can include reducing the amount of time that the UE spends transmitting and/or receiving data and/or control information. Further, reducing active time can include reducing the amount of time that the UE spends processing information or using resources to support these transmit and/or receive activities. Additionally, reducing active time can include reducing the amount of time that the UE spends processing information or using resources to enable certain operational features, as further described below.

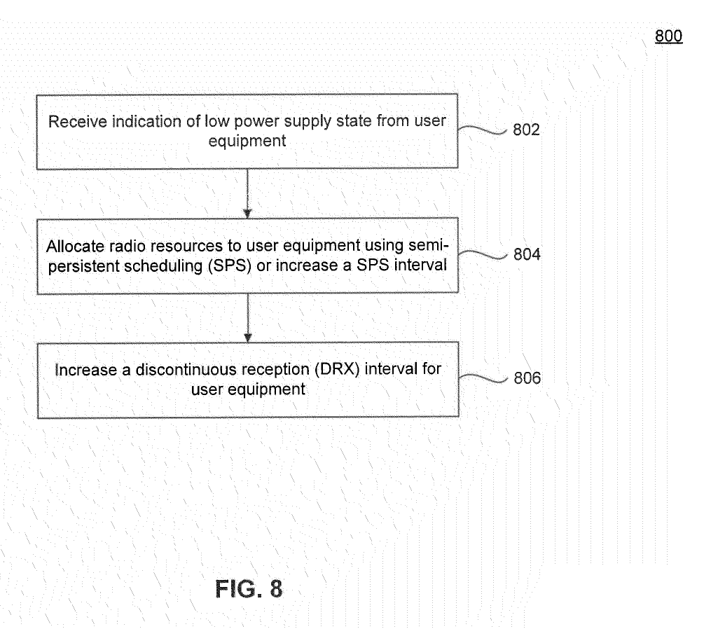

FIG. 8 illustrates another example process 800 for improving the power supply lifetime of a UE according to an embodiment. Example process 800 can be performed by a network entity, such as a serving cell, an eNodeB, or other entity (e.g., EPC entity in LTE) of the network, for example.

As shown in FIG. 8, process 800 begins in step 802, which includes receiving an indication of a low power supply state from the UE. In an embodiment, the indication of a low power supply state is received in a PPI message sent on an uplink control channel by the UE.

Subsequently, in response to the received indication, process 800 proceeds to step 804, which includes allocating radio resources to the UE using a semi-persistent scheduling (SPS) or increasing a SPS interval if the UE is already using a SPS pattern. SPS scheduling includes the network assigning the UE an uplink transmission pattern and/or a downlink reception pattern. The uplink transmission pattern and the downlink reception pattern are valid for respective defined intervals (SPS intervals), which may or may not be the same. During an SPS interval, the UE knows the uplink radio resources for transmitting to the network and/or the downlink radio resources for receiving transmissions from the network. This reduces the active time that the UE spends dynamically scheduling uplink transmissions to the network and/or monitoring the downlink control channel for dynamically scheduled downlink transmissions to the UE.

In an embodiment, the network can use SPS scheduling for both the uplink and the downlink. Accordingly, step 804 further includes allocating uplink radio resources to the UE using a first SPS; and allocating downlink radio resources to the UE using a second SPS. The network can further aid the UE save power by having the first SPS and the second SPS include time aligned, overlapping, or contiguous radio resources, to reduce the active time of the UE. For example, by having time aligned (in the case of Frequency Division Duplexing (FDD)), overlapping, or contiguous uplink transmission time and downlink reception time, the UE can fully power down its modem and any associated circuitry for longer durations.

The network can further aid the UE according to process 800 by, subsequently in step 806, increasing a Discontinuous Reception (DRX) interval for the UE. DRX is a LTE feature that allows a UE to discontinue monitoring a downlink control channel in a specified period of time DRX interval). The DRX interval is determined by the network, which does not schedule any downlink transmissions to the UE during this interval. The UE can thus enter into a DRX inactive state, if desired, during which the UE stops monitoring the downlink control channel. Additionally, the UE can also enter a sleep/low power mode by placing one or more components (e.g., modem) in a low power mode during the DRX interval By using SPS scheduling according to embodiments, the network can further increase the DRX interval for the UE, allowing the UE to spend more time in DRX inactive state, thereby further saving power.

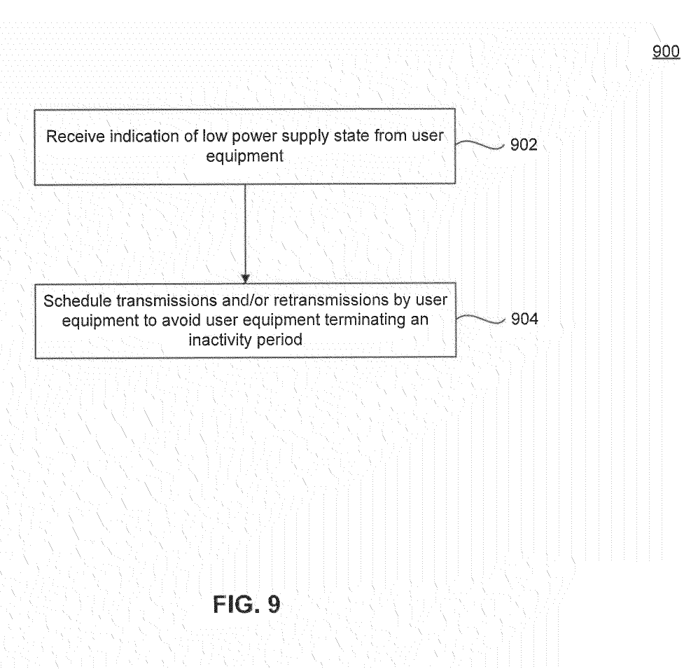

FIG. 9 illustrates another example process 900 for improving the power supply lifetime of a UE according to an embodiment. Example process 900 can be performed by a network entity, such as a serving cell, an eNodeB, or other entity (e.g., EPC entity in LTE) of the network, for example.

As shown in FIG. 9, process 900 begins in step 902, which includes receiving an indication of a low power supply state from the UE. In an embodiment, the indication of a low power supply state is received in a PPI message sent on an uplink control channel by the UE.

Subsequently, in response to the received indication, process 900 proceeds to step 902, which includes scheduling a transmission and/or a retransmission by the UE to avoid the UE terminating an inactivity period. For example, step 902 can include the network scheduling an uplink transmission and/or retransmission outside a DRX interval of the UE. This avoids the UE having to prematurely exit from the DRX inactive state. Similarly, the network can schedule downlink transmissions to the UE to avoid the UE having to terminate an inactivity period.

In an embodiment, step 902 further includes scheduling the uplink/downlink transmission and/or retransmission such that an acknowledgment (ACK) or non-acknowledgment (NACK) in response to the transmission/retransmission needs not to be received/sent within the inactivity period by the UE. This allows the UE to enter an inactivity period (e.g., DRX inactive state) following a transmission and/or retransmission, then send/receive the ACK/NACK at the end of the inactivity period. This embodiment is well suited for voice traffic (e.g., Voice over LTE (VoLTE)), for example, which tends to include periodic bursts that allow for inactivity periods for the UE in between bursts.

Alternatively, or additionally, step 902 further includes limiting a maximum number of allowable uplink retransmissions of a packet from the UE to the network. Typically, after transmitting a packet, the UE monitors the downlink control channel to receive an ACK/NACK in response to the packet transmission. If a NACK is received, the UE retransmits the packet up to a maximum number of allowable retransmissions. The UE can spend a long duration trying to transmit a packet in some conditions, and the packet may be discarded by the network if delayed. According to embodiments, when the network determines that the UE is in a low power supply state, the network can reduce or limit the maximum number of allowable uplink retransmissions by the UE. While this may affect the Quality of Service (QoS) for the UE, it allows the UE to save much needed power when in a low power supply state. In other embodiments, the network can remedy the QoS degradation by reducing the uplink modulation order and/or coding rate to reduce the need for uplink retransmissions.

In the same context of avoiding terminating an inactivity period, the UE can delay RACH and/or Buffer State Report (BSR) transmissions by the UE to fall outside the inactivity period. RACH transmissions are used by the UE, for example, for call setup. BSR transmissions are used by the UE to inform the network of the amount of data pending transmission in an uplink buffer at the UE. By delaying these transmissions, the UE can remain, in an inactivity period at the expense of slightly increasing call setup time.

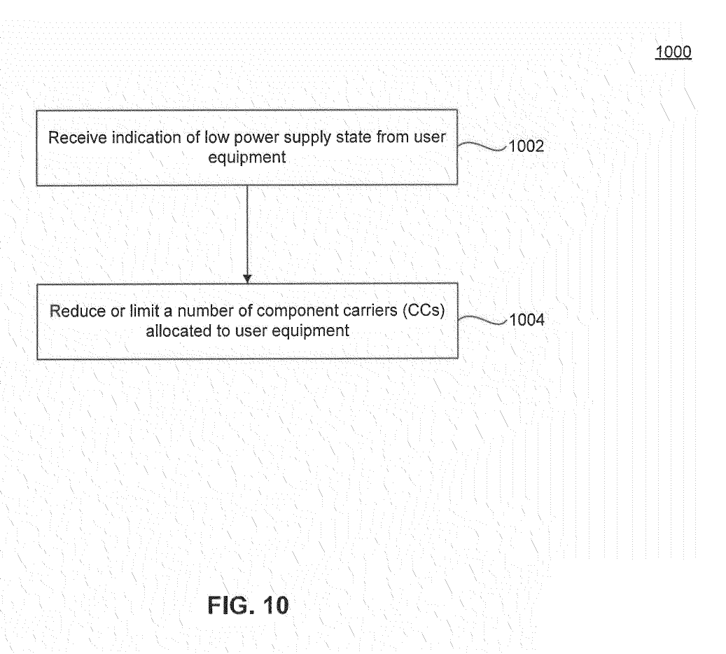

FIG. 10 illustrates another example process 1000 for improving the power supply lifetime of a UE according to an embodiment. Example process 1000 can be performed by a network entity, such as a serving cell, an eNodeB, or other entity (e.g., EPC entity in LTE) of the network, for example.

As Shown in FIG. 10, process 1000 begins in step 1002, which includes receiving an indication of a low power supply state from the UE. In an embodiment, the indication of a low power supply state is received in a PPI message sent on an uplink control channel by the UE.

Subsequently, in response to the received indication, process 1000 proceeds to step 1002, which includes reducing or limiting a number of component carriers (CCs) allocated to the UE. As described, Carrier Aggregation (CA) is a feature of Release-10 of the 3^{rd} Generation Partnership Project (3GPP) LTE-Advanced standard, which allows for multiple resource blocks (defined in terms of frequency and/or time) from/to multiple respective serving cells to be logically grouped together (aggregated) and allocated to the same UE. The aggregated resource blocks are known as component carriers (CCs) in the LTE-Advanced standard. The UE may thus receive/transmit multiple CCs (more specifically, receive/transmit data over the multiple CCs) simultaneously from/to the multiple respective serving cells, thereby effectively increasing the downlink/uplink bandwidth of the UE.

According to embodiments, when the UE is in a low power supply state, the network reduces or limits (sets an upper limit) the number of CCs that can be allocated by the UR For example, the network can limit the number of CCs for the UE even when the UE's traffic Can benefit from higher throughput. In another example, the network can configure the UE as a single carrier UE (disabling CA for the UE). Reducing or limiting the number of CCs allocated to the UE reduces the UE's burden of performing uplink/downlink operations and/or intra-frequency and inter-frequency measurements (measurements of neighboring cells on the same or different carrier frequency) for multiple carriers, which saves significant power at the UE. Additionally, the UE can power down one or more transmit and/or receive chains with fewer CCs allocated to the UE. For example, referring to example UE receiver architecture 300 illustrated in FIG. 3, the UE can turn off one or the other of the two receive chains when configured as a single carrier UE.

FIG. 11 illustrates another example process 1100 for improving the power supply lifetime of a UE according to an embodiment Example process 1100 can be performed by a UE and can be UE-triggered with or without the network being aware of the UE's power supply state and/or of the execution of the process at the UE.

Example process 1100, as further described below, provides a method for dynamically determining, based on the power supply state of the UE, how to use a receive chain configured for one CC when a measurement gap (dedicated time interval that the network schedules for the UE to make inter-frequency measurements of other neighboring cells) is scheduled for another CC by the network. For the sake of illustration, it is assumed that the UE has two receive chains and two CCs allocated, each associated with a respective one of the two receive chains. As would be understood by a person of skill in the art based on the teachings herein, however, embodiments are not limited to this example illustration and can be extended to scenarios with more than two CCs/receive chains per UE. An assumption in example process 1100 is that the network schedules measurement gaps on a per CC basis when the UE is configured for CA (not on a per UE basis as done conventionally). As such, according to an embodiment, for different CCs, the UE can have two different measurement gaps scheduled by the network.

As shown in FIG. 11, process 1100 begins in step 1102, which includes receiving an indication of a measurement gap for a first component carrier (CC) allocated to the UE. As noted above, measurement gaps are scheduled by the network. According to embodiments, the indication of a measurement gap specifies which CC of the CCs allocated to the UE the measurement gap applies to. During the specified measurement gap, the UE's serving cells do not transmit to the UE to allow the UE to make the necessary measurements from other neighboring cells.

Subsequently, process 1100 proceeds to step 1104, which includes determining whether or not the UE is in a low power supply state. In an embodiment, step 1104 includes performing step 402 described above with reference to FIG. 4 to determine the power supply state of the UE.

If the UE is in a low power supply state in step 1104, process 1100 proceeds to step 1106, which includes performing inter-frequency measurements using a first receive chain associated with the first. CC during the measurement gap, and turning off a second receive chain associated with a second CC during the measurement gap. Turning off the second receive chain during the measurement gap allows the UE to save significant power without any cost to the UE because the serving cells transmit nothing to the UE during the measurement gap and the first receive chain is sufficient to perform the necessary inter-frequency measurements. However, without the signaling of measurement gaps per CC as in embodiments, the TIE cannot normally turn off the second receive chain.

Otherwise, if the UE is not in a low power supply state in step 1104, process 1100 proceeds to step 1108, which includes performing inter-frequency measurements using the first receive chain associated with the first CC during the measurement gap, and performing extra measurements (e.g., inter-frequency measurements) or data reception using the second receive chain associated with the second CC during the measurement gap. The extra measurements or data reception with the second receive chain can improve the mobility performance or the throughput of the UE. According, example process 1100 provides a method for dynamically configuring the UE for more power saving or better mobility performance/throughput based on the power supply state of the UE.

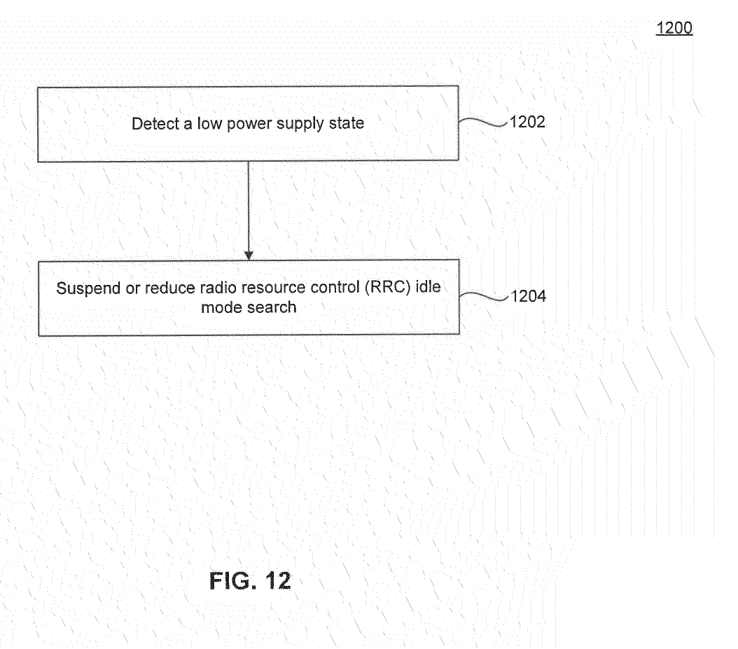

FIG. 12 illustrates another example process 1200 for improving the power supply lifetime of a UE according to an embodiment. Example process 1200 can be performed by a UE and can be UE-triggered with or without the network being aware of the UE's power supply state and/or of the execution of the process at the UE.

As shown in FIG. 12, process 1200 begins in step 1202, which includes detecting a low power supply state. In an embodiment, step 1202 includes performing step 402 described above with reference to FIG. 4 to determine the power supply state of the UE.

Subsequently, in response to detecting the low power supply state, process 1200 includes in step 1204 suspending or reducing radio resource control (RRC) idle mode search at the UE. RRC idle mode search includes various types of searches that the UE performs when the UE is in the RRC Idle mode (i.e., no data connection to the network).

For example, in an embodiment, the UE can suspend or reduce the frequency of higher priority public land module network (HPPLMN) search at the UE. HPPLMN search is a periodic search that the UE performs in RRC Idle mode when the UE is camped on a Visited Public Land Mobile Network (VPLMN). Specifically, the UE performs the HPPLMN search during DRX intervals when the UE is permitted to not monitor the downlink control channel. Typically, the HPPLMN includes searching, for every radio access technology (RAT) supported by the UE, across all supported frequency bands per RAT, over all frequency channels (E-UTRA Absolute Radio Frequency Channel Number (EARFCN)) per band. For each EARFCN being searched, the UE performs measurements to detect cells available on the searched EARFCN. Cells may or may not be detected on a given EARFCN. For one or more of the detected cells (e.g., strongest cell), the UE may then decode information contained in a broadcast channel (SIB, MIB1) of the cell to determine the PLMN identity list broadcast of the cell. As such, the HPPLMN search is a significantly power consuming process, especially when the UE is roaming because the UE may never find its preferred PLMN. Embodiments thus provide for the UE to suspend or reduce the frequency of HPPLMN searches to reduce power consumption. While the network may prefer that the UE camp on its preferred PLMN, not doing so does not affect the UE's performance.

In another embodiment, alternatively or additionally, the UE can suspend or reduce the frequency of higher priority frequency search at the UE. Higher priority frequency search is a periodic search that the UE performs in RRC Idle mode when the UE is not assigned to a serving cell of a highest priority frequency. Specifically, after the UE camps on a particular cell, the UE decodes a list of higher priority frequencies by decoding System Information Block 3 (SIB3) and System information Block 4 (SIB4) broadcast by the cell. In the higher priority frequency search, the UE tries to detect cells on each frequency in the list, and if the UE detects a cell of higher signal strength than the current serving cell the UE moves to the detected cell with higher priority frequency. Like the HPPLMN search, the higher priority frequency search can consume a lot of power at the UE. Embodiments thus provide for the UE to suspend or reduce the frequency of higher priority frequency search to reduce power consumption. The performance is not affected if the UE remains connected to a lower priority frequency because connecting to a higher priority frequency is merely to help the network (e.g., for load balancing).

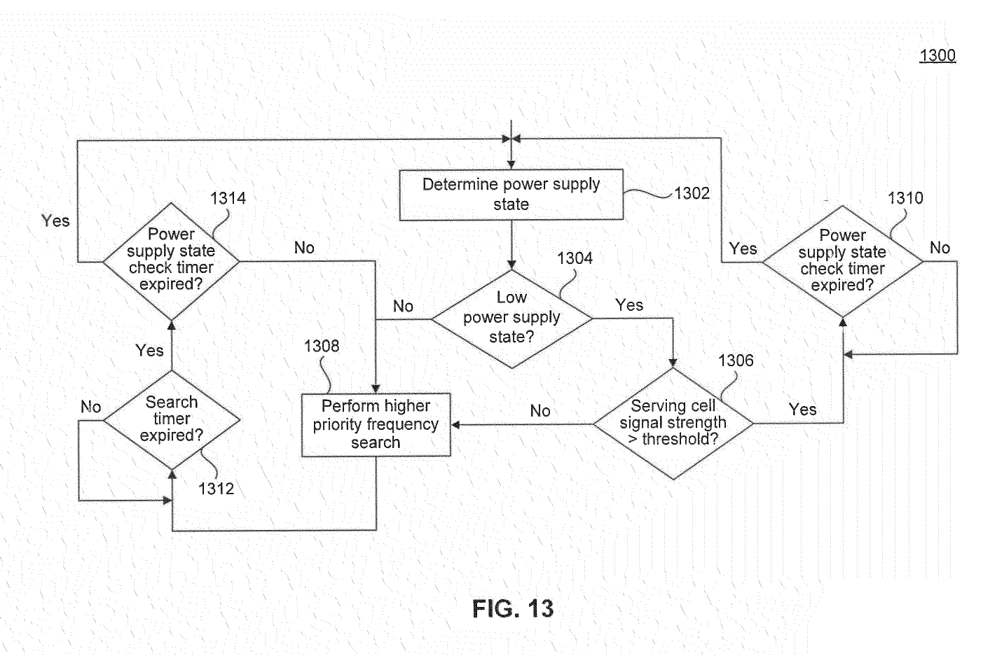

FIG. 13 illustrates another example process 1300 for improving the power supply lifetime of a UE according to an embodiment. Example process 1300 can be performed by a UE and can be UE-triggered with or without the network being aware of the UE's power supply state and/or of the execution of the process at the UE. Specifically, example process 1300 provides another way for relaxing the performance of the higher priority frequency search by performing the higher priority frequency search only when the signal strength of the serving cell is below a predetermined threshold. Conventionally, the higher priority frequency search is performed irrespective of the signal strength of the serving cell.

As shown in FIG. 13, process 1300 begins in step 1302, which includes determining the power supply state of the UE. This can be similar to step 402 described above with reference to FIG. 4 Subsequently, step 1304 includes determining whether or not the UE is in a low power supply state.

If the UE is not in a low power supply state, process 1300 proceeds to step 1308, which includes performing the higher priority frequency search, and then (if the search does not result in moving to a higher priority frequency) proceeds to step 1312, where it remains until a search timer, which indicates the time for the next search, expires. When the search timer expires, process 1300 proceeds to step 1314, which includes determining whether or not a power supply state check timer has expired. The power supply state check timer governs a periodic cycle for checking the power supply state. If the power supply state check timer has expired in step 1314, process 1300 returns to step 1302, where the power supply state is checked again. Otherwise, process 1300 returns to step 1308 to perform another higher priority frequency search.

If the UE is in a low power supply state in step 1304, process 1300 proceeds to step 1306, which includes determining whether the serving cell signal strength is greater than a predetermined threshold. In an embodiment, the predetermined threshold is communicated by the serving cell to the UE (e.g., S_non_intra). If the serving cell signal strength is lower than the predetermined threshold, process 1300 proceeds to step 1308. Otherwise, process 1300 proceeds to step 1310, where it remains until the power supply state check time expires, then returns to step 1302.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, but should be defined only in accordance with the following claims and their equivalents.

What is claimed is:

1. A method for improving a power supply lifetime of a user equipment (UE), comprising:
receiving an indication of a low power supply state from the UE; and
reducing at least one of non-time critical reporting and channel feedback reporting from the UE, responsive to the received indication.

2. The method of claim 1, wherein reducing the non-time critical reporting comprises:
reducing transmission of at least one of: automatic neighbor relation (ANR) measurements, mobility robustness optimization (MRO) related messages, and Random Access Channel (RACH) configuration optimization messages from the UE.

3. The method of claim 1, wherein reducing channel feedback reporting comprises:
reducing transmission of at least one of: channel quality indicator (CQI) messages and Sounding Reference Signals (SRSs).

4. The method of claim 1, wherein reducing channel feedback reporting comprises reducing transmission of channel quality indicator (CQI) messages, the method further comprising:
reducing at least one of downlink modulation order and downlink coding rate for the UE.

5. The method of claim 1, wherein reducing channel feedback reporting comprises reducing transmission of Sounding Reference Signals (SRSs), the method further comprising:
reducing at least one of uplink modulation order and uplink coding rate for the UE.

6. A method for improving a power supply lifetime of a user equipment (UE), comprising:
receiving an indication of a low power supply state from the UE; and
allocating radio resources to the UE, responsive to the received indication, to reduce active time at the UE.

7. The method of claim 6, wherein allocating the radio resources to the UE comprises:
allocating the radio resources to the UE using semi-persistent scheduling (SPS).

8. The method of claim 7, further comprising:
increasing a discontinuous reception (DRX) interval for the UE.

9. The method of claim 7, wherein allocating the radio resources to the UE using SPS comprises:
allocating uplink radio resources to the UE using a first SPS; and
allocating downlink radio resources to the UE using a second SPS,
wherein the first SPS and the second SPS include time aligned, overlapping, or contiguous radio resources.

10. The method of claim 6, wherein allocating the radio resources to the UE comprises:
increasing a semi-persistent scheduling (SPS) interval associated with the UE.

11. The method of claim 6, wherein allocating the radio resources to the UE comprises at least one of:
scheduling a transmission to or from the UE to avoid the UE terminating an inactivity period; and
scheduling the transmission such that an acknowledgment or non-acknowledgment in response to the transmission is sent or received outside the inactivity period by the UE.

12. The method of claim 6, wherein allocating the radio resources to the UE comprises:
limiting a maximum number of allowable retransmissions of a packet from the UE.

13. The method of claim 6, Wherein allocating the radio resources to the UE comprises:
reducing or limiting a number of component carriers (CCs) allocated to the UE.

14. A method for improving a power supply lifetime of a user equipment UE), comprising:
determining a power supply state of the UE; and
communicating the power supply state from the UE to a base station.

15. The method of claim 14, wherein communicating the power supply state from the UE to the base station comprises:
sending a power preference indication (PPI) message from the UE to the base station, wherein the PPI message includes a power mode preference of the UE.

16. The method of claim 15, further comprising:
selecting, by the UE, the power mode preference of the UE responsive to the determined power supply state, wherein the power mode preference includes a low power mode when the determined power supply state corresponds to a low power supply state and a normal power mode when the determined power supply state corresponds to a normal power supply state.

17. The method of claim 14, wherein the power supply state corresponds to a low power supply state, the method further comprising:
suspending or reducing a radio resource control (RRC) idle mode search at the UE.

18. The method of claim 17, wherein suspending or reducing the RRC idle mode search comprises:
suspending or reducing a higher priority public land mobile network (PLMN) search at the UE.

19. The method of claim 17, wherein suspending or reducing the RRC idle mode search comprises:
suspending or reducing a higher priority frequency search at the UE.

20. The method of claim 19, wherein suspending or reducing the higher priority frequency search comprises:
performing the higher priority frequency search only when a serving cell signal strength is below a predetermined threshold.
